(19) United States
(12) Patent Application Publication
(10) Pub. No.: US 2026/0086584 A1
(43) Pub. Date: Mar. 26, 2026

(54) THERMOSTATIC MIXING VALVE

(71) Applicant: PITTWAY SARL, Rolle (CH)

(72) Inventors: Steffen Raule, Eberbach (DE); Ralf Hilbers, Waldbrunn (DE)

(73) Assignee: PITTWAY SARL, Rolle (CH)

(21) Appl. No.: 19/110,549

(22) PCT Filed: Sep. 11, 2023
(86) PCT No.: PCT/EP2023/074829

§ 371 Date: Mar. 11, 2025

(30) Foreign Application Priority Data
Sep. 13, 2022 (EP) 22195421.7

(51) Int. Cl. G05D 23/13

(52) U.S. Cl. CPC G05D 23/134

(57) ABSTRACT

Thermostatic mixing valve (10) comprising a housing (11), the housing comprising a first inlet port (12) for water having a first temperature, a second inlet port (13) for water having a second temperature, and an outlet port (14) for mixed water having a mixing temperature depending on a mixing ratio of the water having the first temperature and of the water having the second temperature. The thermostatic mixing valve further comprises a valve insert (15) positioned within the housing (11), wherein the valve insert has a tubular element (16), a thermal element (17) and a spring element (18), wherein the tubular element (16), the thermal element (17) and the spring element (18) control together the mixing ratio of the mixed water such that an actual value of the mixing temperature corresponds to a nominal value of the mixing temperature. The thermostatic mixing valve further comprises a first setting unit (19) having a first spindle (21) and being configured to set the nominal value of the mixing temperature. The thermostatic mixing valve further comprises a second setting unit (20) having a second spindle (22) and being configured to select an operation mode of the thermostatic mixing valve, wherein the second spindle (22) is guided within the first spindle (21), and wherein the second spindle (22) is configured to provide a linear movement of the second spindle (22) relative to the first spindle (21) when rotating the second spindle (22) relative to the first spindle (21) in order to select either a first operation mode or a second operation mode for the thermostatic mixing valve.

The invention relates to a thermostatic mixing valve.

The product leaflet “resideo Safety Valves, Braukmann TM50, ENOH-1326GE23 R0420, Resideo Technologies, @ 2020,” discloses a thermostatic mixing valve according to the prior art. Said thermostatic mixing valve comprises the following: A housing, the housing having a first inlet port for water having a first temperature, a second inlet port for water having a second temperature, and an outlet port for mixed water having a mixing temperature depending on a mixing ratio of the water having the first temperature and of the water having the second temperature. A valve insert positioned within the housing, wherein the valve insert has a tubular element, a thermal element and a spring element, wherein the tubular element, the thermal element and the spring element of the valve insert control together the mixing ratio of the mixed water such that an actual value of the mixing temperature corresponds to a nominal value of mixing temperature. A setting unit having a spindle and a handle, wherein setting unit is configured to set the nominal value of the mixing temperature. The spindle rotates and translates upon rotation of the handle. The relative translational position of the spindle within the housing defines the nominal value of mixing temperature. Said thermostatic mixing valve can be operated in a first operation mode only, namely in a temperature control operation mode. The same cannot be operated in a second operation mode, namely in a thermal disinfection operation mode.

EP 1 118 049 B1 discloses another thermostatic mixing valve according to the prior art. This thermostatic mixing valve can also be operated in a first operation mode only, namely in a temperature control operation mode. The same cannot be operated in a second operation mode, namely in a thermal disinfection operation mode.

AU 2017 200 743 B2 discloses thermostatic mixing valve which can be operated in a first operation mode namely in a temperature control operation mode, and in a second operation mode, namely in a thermal disinfection operation mode. The thermostatic mixing valve disclosed in AU 2017 200 743 B2 comprises a gripping mechanical key. The gripping mechanical key is used to set the nominal value of the mixing temperature by rotating a head or spindle. Further on, the gripping mechanical key is used to select the operation mode of the thermostatic mixing valve, namely either the first operation mode, namely the temperature control operation mode, or the second operation mode, namely the disinfection operation mode, by lifting or lowering a piston guided by the head or spindle. This thermostatic mixing valve requires an additional spring element acting on the head or spindle and on the piston. Further, there is a risk that the position of the head or spindle is changed unintentionally when using the gripping mechanical key.

Against this background, a novel thermostatic mixing valve is provided.

The thermostatic mixing valve according to the present invention comprises a housing, the housing comprising a first inlet port for water having a first temperature, a second inlet port for water having a second temperature, and an outlet port for mixed water having a mixing temperature depending on a mixing ratio of the water having the first temperature and of the water having the second temperature.

The thermostatic mixing valve according to the present invention further comprises a valve insert positioned within the housing, wherein the valve insert has a tubular element, a thermal element and a spring element, wherein the tubular element, the thermal element and the spring element of the valve insert control together the mixing ratio of the mixed water such that an actual value of the mixing temperature corresponds to a nominal value of mixing temperature.

The thermostatic mixing valve according to the present invention further comprises a first setting unit having a first spindle and being configured to set the nominal value of the mixing temperature.

The thermostatic mixing valve according to the present invention further comprises a second setting unit having a second spindle and being configured to select an operation mode of the thermostatic mixing valve, wherein the second spindle is guided within the first spindle, and wherein the second spindle is configured to provide a linear movement of the second spindle when rotating the second spindle relative to the first spindle in order to select either a first operation mode or a second operation mode for the thermostatic mixing valve.

The first operation mode may also be called temperature control operation mode.

The second operation mode may also be called thermal disinfection operation mode.

The thermostatic mixing valve according to the present invention does not require an additional spring element. Further, the risk that the position of the first spindle is changed unintentionally is minimized.

If the first operation mode is selected by the second setting unit, the tubular element, the thermal element and the spring element control together the mixing ratio of the mixed water such that the actual value of the mixing temperature corresponds to the nominal value set by the first setting unit.

If the second operation mode is selected by the second setting unit, the tubular element, the thermal element and the spring element control together the mixing ratio of the mixed water such that the actual value of the mixing temperature corresponds to a disinfection value set by the second setting unit.

In a first embodiment of the thermostatic mixing valve according to the present invention, the first setting unit comprises the first spindle and a locking element, wherein the first spindle is configured to provide a linear movement of the first spindle when rotating the first spindle to set the nominal value of the mixing temperature, and wherein the locking element is configured to lock the nominal value of the mixing temperature set by the first spindle. In this embodiment the nominal value of the mixing temperature is factory set and cannot be changed in the field.

In a second embodiment of the thermostatic mixing valve according to the present invention, the first setting unit comprises the first spindle and a first handle. The first handle and the first spindle are configured to provide a linear movement of the first spindle upon a rotation of the first handle in order to set the nominal value of the mixing temperature. In this embodiment the nominal value of the mixing temperature can be changed in the filed by using the first handle.

Preferably, the second setting unit comprises the second spindle and an actuator, wherein the actuator is configured to provide the rotation of the second spindle relative to the first spindle, and wherein the second spindle is configured to provide the linear movement of the same upon the rotation of the second spindle in order to select either the first operation mode or the second operation mode for the thermostatic mixing valve. A rotation of the first spindle causes a linear movement of the first spindle and together with the linear movement of the first spindle a linear movement of the second spindle. A rotation of the second spindle causes a linear movement of the second spindle while the position of the first spindle remains unchanged. This provides a simple and reliable design of the thermostatic mixing valve. The same does not require an additional spring element. Further, there risk that the position of the first spindle is changed unintentionally is minimized.

Preferred developments of the invention are provided by the dependent claims and the description which follows.

Exemplary embodiments are explained in more detail on the basis of the drawing, in which:

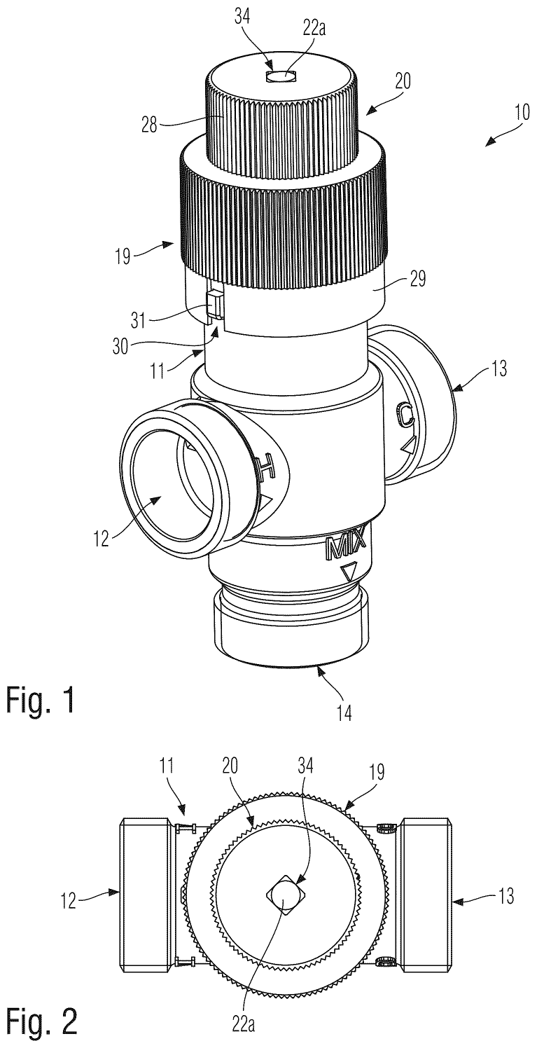

FIG. 1 shows a perspective view of a thermostatic mixing valve according to a first embodiment of the invention;

FIG. 2 shows a top view of the thermostatic mixing valve of FIG. 1;

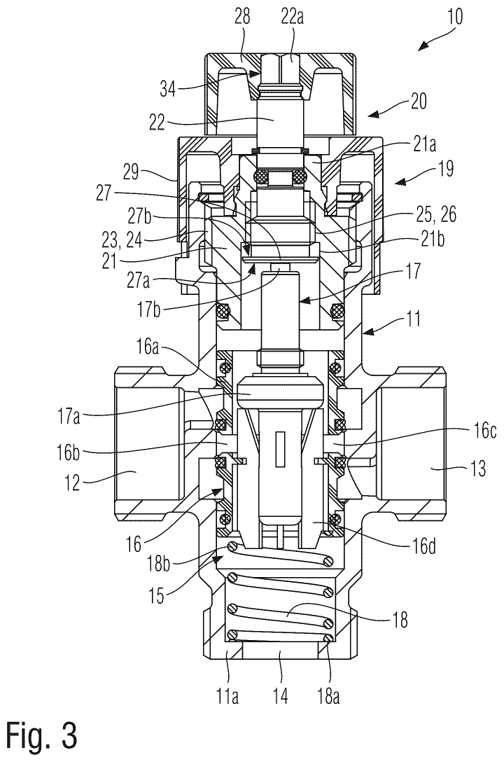

FIG. 3 shows a cross-section of the thermostatic mixing valve of FIG. 1 in a first operation mode of the same which may also be called temperature control operation mode;

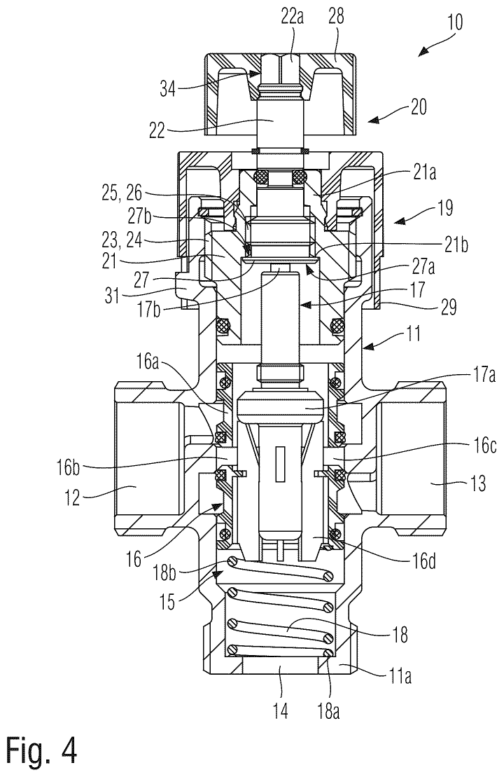

FIG. 4 shows a cross-section of the thermostatic mixing valve of FIG. 1 in a second operation mode of the same which may also be called thermal disinfection operation mode;

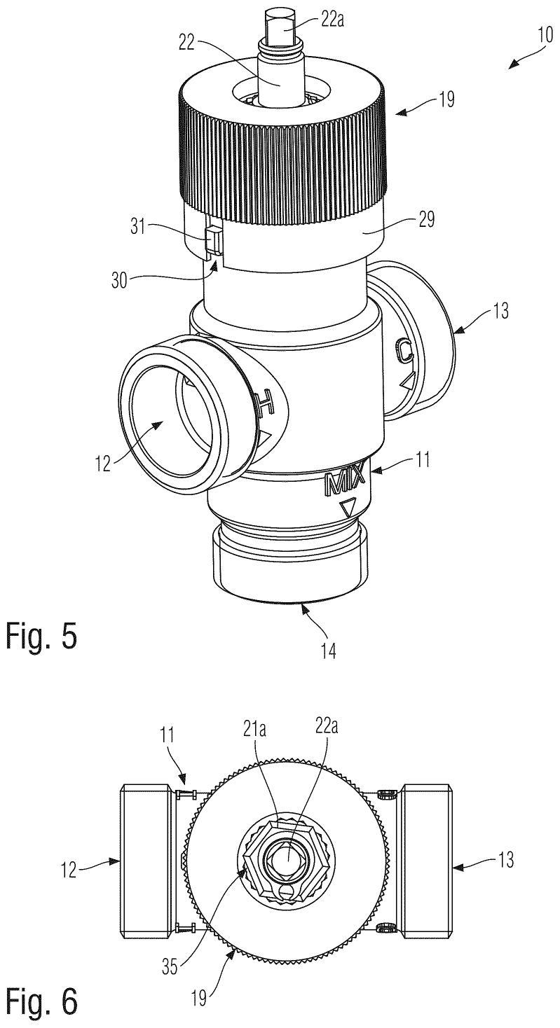

FIG. 5 shows a perspective view of a partly disassembled thermostatic mixing valve according to the invention of FIG. 1;

FIG. 6 shows a top view of FIG. 5,

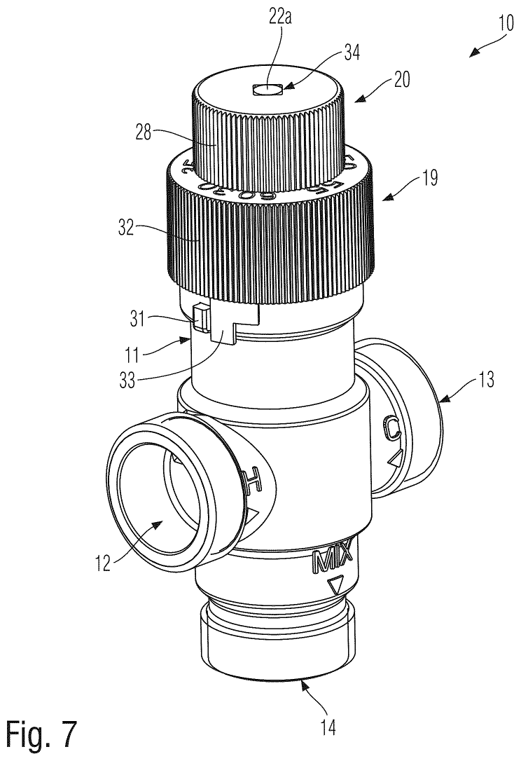

FIG. 7 shows a perspective view of a thermostatic mixing valve according to a second embodiment of the invention.

FIGS. 1 to 6 illustrate a first embodiment of a thermostatic mixing valve 10 according to the invention.

The thermostatic mixing valve 10 comprises a housing 11. The housing 11 has a first inlet port 12 for water having a first temperature, a second inlet port 13 for water having a second temperature, and an outlet port 14 for mixed water having a mixing temperature depending on a mixing ratio of the water having the first temperature and of the water having the second temperature.

The water having the first temperature is usually called hot water and the first inlet port 12 is usually called hot water inlet port. The water having the second temperature is usually called cold water and the second inlet port 13 is usually called cold water inlet port.

The thermostatic mixing valve 10 comprises a valve insert 15 positioned within the housing 11. The valve insert 15 comprises a tubular element 16, a thermal element 17 and a spring element 18. The tubular element 16, the thermal element 17 and the spring element 18 control together the mixing ratio of the mixed water such that an actual value of the mixing temperature corresponds to a nominal value of mixing temperature.

The tubular element 16 is guided within the housing 11 and can move in linear or translational direction relative to the housing 11. The tubular element 16 has an outer wall section 16a with openings 16b, 16c.

Depending on the relative translational position of the tubular element 16 within the housing 11, the opening 16b is in communication with the first inlet port 12 and/or the opening 16c is in communication second inlet port 13.

The spring element 18 abuts with a first end 18a against the housing 11, namely against a section 11a of the housing 11 close to the outlet port 14 of the housing 11. The spring element 18 abuts with a second end 18b against the tubular element 16, namely against an end of the outer wall section 16a of the tubular element 16. The spring force of the spring element 18 tends to push the tubular element 16 in a direction away from the outlet port 14 of the housing 11.

The thermal element 17 is partially accommodated within the tubular element 16. The thermal element 17 abuts against the tubular element 16. The tubular element 16 comprises ribs 16d positioned radially inwards of the outer wall section 16a. A first portion 17a of the thermal element 17 abuts against said ribs 16d of the tubular element 16.

The thermostatic mixing valve 10 comprises a first setting unit 19 and a second setting unit 20.

The first setting unit 19 has a first spindle 21 and is configured to set the nominal value of the mixing temperature.

The second setting unit 20 has a second spindle 22 and is configured to select an operation mode of the thermostatic mixing valve 10, namely either a first operation mode in which the nominal value of the mixing temperature set by the first setting unit 19 applies, or a second operation mode in which in which the nominal value of the mixing temperature set by the first setting unit 19 does not apply. The first operation mode may also be called temperature control operation mode. The second operation mode may also be called thermal disinfection operation mode.

The second spindle 22 of the second setting unit 20 is guided within an opening of the first spindle 20 of the first setting unit 19.

The second spindle 22 of the second setting unit 20 is configured to provide a linear movement of the second spindle 22 relative to the first spindle 21 and relative to the housing 11 when rotating the second spindle 22 relative to the first spindle 21 in order to select either the first operation mode or the second operation mode for the thermostatic mixing valve 10.

As mentioned above, in the first operation mode the nominal value of the mixing temperature set by the first setting unit 19 applies. So, in the first operation mode the tubular element 16, the thermal element 17 and the spring element 18 control together the mixing ratio of the mixed water such that the actual value of the mixing temperature corresponds to the nominal value set by the first setting unit 19. In the second operation mode the nominal value of the mixing temperature set by the first setting unit 19 does not apply. In the second operation mode the tubular element 16, the thermal element 17 and the spring element 18 control together the mixing ratio of the mixed water such that the actual value of the mixing temperature corresponds to a disinfection value set by the second setting unit 20.

As mentioned above, the first setting unit 19 has the first spindle 21. The first spindle 21 comprises an outer thread 23 engaging an inner thread 24 of the housing 11. The second setting unit 20 has the second spindle 22. The second spindle 22 comprises an outer thread 25 engaging an inner thread 26 of the first spindle 21, namely of the opening of the first spindle 21 in which the second spindle 22 is guided.

A rotation of the second spindle 22 relative to the first spindle 21 causes a linear movement of the second spindle 22 relative to the first spindle 21 and relative to the housing 11 while the position of the first spindle 21 remains unchanged. So, when second spindle 22 becomes rotated causing a linear movement of the second spindle 22, the first spindle 21 does neither rotate nor translate.

A rotation of the first spindle 21 relative to the housing 11 causes a linear movement of the first spindle 21 relative to the housing 11 and also a linear movement of the second setting unit 20 relative to the housing 11. So, when first spindle 21 becomes rotated causing a linear movement of the first spindle 21, also the second spindle 22 does translate. However, when first spindle 21 becomes rotated the relative position between first spindle 21 and the second spindle does not change.

The second spindle 22 comprises a front element 27 having a front surface 27a facing towards the thermal element 17. The thermal element 17, namely a second section 17b of the same, abuts against said front surface 27a of the front element 27 of the second spindle 22.

The length of the thermal element 17 depends on the mixing temperature of the mixed water. With an increasing mixing temperature, the length of the thermal element 17 increases. With a decreasing mixing temperature, the length of the thermal element 17 decreases.

If the length of the thermal element 17 increases, the thermal element 17 provides an increasing force to the tubular element 16 thereby moving the tubular element 16 against the spring force provided by the spring element 18 in a direction towards the outlet port 14.

If the length of the thermal element 17 decreases, the thermal element 17 provides a decreasing force to the tubular element 16 thereby moving the tubular element 16 in a direction away from the outlet port 14 by the spring force provided by the spring element 18.

The second setting unit 20 comprises the second spindle 22 and an actuator 28. The actuator 28 is configured to provide the rotation of the second spindle 22 relative to the first spindle 21. The second spindle 22 is configured to provide the linear movement of the same upon the rotation of the second spindle 22 by the actuator 28 in order to select either the first operation mode or the second operation mode for the thermostatic mixing valve 10.

In FIGS. 1 to 6 the actuator 28 is provided by a handle.

Alternatively, the actuator 28 may be provided by a motor to allow an automated rotation of the second spindle 22 of the second setting unit 20.

The actuator 28 of the second setting unit 20 is non-rotatably connected to the second spindle 22 of the second setting unit 20. So, a rotation of the actuator 28 results into a rotation of the second spindle 22 and by the engagement of the threads 25, 26 also into a linear movement of the second spindle 22. This non-rotatably connection of the actuator 28 and the second spindle 28 is in FIGS. 1 to 6 provided in such a manner, that an end section 22a of the second spindle 22 having a polygonal cross-section, preferably a square cross-section, penetrates into an opening of the actuator 28 having also a polygonal cross-section, preferably a square cross-section.

In the first embodiment of a thermostatic mixing valve 10 illustrated in FIGS. 1 to 6, the first setting unit 19 comprises the first spindle 21 and a locking element 29. The first spindle 21 is configured to provide the linear movement of the first spindle 21 when rotating the first spindle 21 to set the nominal value of the mixing temperature. The locking element 29 is configured to lock the first spindle 21 and thereby the nominal value of the mixing temperature set by the first spindle 21. The locking element 29 has a slot 30 acting together with a protrusion 31 provided at the outer surface of the housing 11. Once the relative position of the first spindle 21 relative to the housing 11 has been set, preferably during an assembly of the thermostatic mixing valve 10 in a factory, the relative position of the first spindle 21 relative to the housing 11 and thereby the nominal value of the mixing temperature defined by said relative position is fixed by the locking element 29, namely by attaching the locking element 29 to the first spindle 21 while inserting the protrusion 31 into the slot 30.

When the nominal value of the mixing temperature defined by said relative position of the first spindle 21 of the first setting unit 19 relative to the housing 11 is fixed by the locking element 29 of the first setting unit 19, the relative position of the second spindle 22 of the second setting unit 20 can be changed by the actuator 28 of the second setting unit 20, namely by rotating the second spindle 21 by the actuator 28, wherein the second spindle 21 rotates and translates upon rotation by the actuator 28.

When the second setting unit 20 is in the relative position shown in FIGS. 1 and 3, the first operation mode for the thermostatic mixing valve 10 is selected. In said relative position the actuator 28 abuts on the locking element 29. In said first operation mode, the nominal value of the mixing temperature set by the first setting unit 19 applies. In the first operation mode, the tubular element 16, the thermal element 17 and the spring element 19 control together the mixing ratio of the mixed water so that the actual value of the mixing temperature corresponds to the nominal value of the mixing temperature set by the first setting unit 19.

When the second setting unit 20 is in the relative position shown in FIG. 4, the second operation mode for the thermostatic mixing valve 10 is selected. In said second operation mode, the nominal value of the mixing temperature set by the first setting unit 19 does not apply. In the thermal disinfection control operation mode, the tubular element 16, the thermal element 17 and the spring element 19 control together the mixing ratio of the mixed water so that the actual value of the mixing temperature corresponds to the disinfection value set by the second setting unit 20. In FIG. 4, the actuator 28 does not abut on the locking element 29. In the second operation mode the actuator 28 is lifted up from the locking element 29.

A change of the relative position between the second spindle 22 of the second setting unit 20 and the first spindle 21 of the first setting unit 19 caused by a rotation of the actuator 28 of the second setting unit 20 does not affect the relative position between the first spindle 21 of the first setting unit 19 and the housing 11.

So, after a thermal disinfection is completed, the thermostatic mixing valve 10 can be transferred back from the disinfection operation mode into the first operation mode by moving the second setting unit 20 in the relative position shown in FIGS. 1 and 3.

As mentioned above, in the first operation mode shown in FIG. 3 the actuator 28 abuts on the locking element 29. This means that the actuator 28 rests on the locking element 29 in the first operation mode.

As shown in FIG. 3, in the first operation mode the front surface 27a of the front element 27 contacts the thermal element 17 and an opposing back surface 27b of the front element 27 does not contact a stop 21b provided by the first spindle 21.

As also mentioned above, in the second operation mode shown in FIG. 4 the actuator 28 does not abut on or against the locking element 29. This means that the actuator 28 is lifted up from the locking element 29 in the second operation mode.

As shown in FIG. 4, in the second operation mode the front surface 27a of the front element 27 contacts the thermal element 17 and the opposing back surface 27b of the front element 27 contacts the stop 21b provided by the first spindle 21.

The distance between the back surface 27b of the front element 27 and the stop 21b provided by the first spindle 21 shown in FIG. 3 corresponds to the maximum linear movement of the second spindle 22 relative to the first spindle 21 when transferring the thermostatic mixing valve 10 from the first operation mode shown in FIG. 3 into the second operation mode shown in FIG. 4.

FIG. 7 illustrates a second embodiment of a thermostatic mixing valve 10 according to the invention. The embodiment of FIG. 7 differs from the embodiment of FIG. 7 merely by the replacement of the locking element 29 of the fist setting unit 19 by a handle 32. All other details remain unchanged. So, in the first operation mode of the thermostatic mixing valve 10 shown in FIG. 7 the actuator 28 abuts on the locking element 29 while in the in the second operation mode of the thermostatic mixing valve 10 shown in FIG. 7 the actuator 28 does not abut on or against the handle 32 but is lifted up from the handle 32.

The handle 32 and the first spindle 21 are configured to provide a linear movement of the first spindle 21 upon a rotation of the handle 29 in order to set the nominal value of the mixing temperature. In the embodiment shown in FIG. 7, the nominal value of the mixing temperature can be changed in the field. A stop member 33 of the handle 32 acts together with the protrusion 31 of the housing 11 to limit the rotation of the handle 32. The handle 32 can be rotated once by approximately 360°.

The handle 32 of the first setting unit 19 is non-rotatably connected to the first spindle 21 of the first setting unit 19. So, a rotation of the handle 32 results into a rotation of the first spindle 21 and by the engagement of the threads 23, 24 also into a linear movement of the first spindle 21. This non-rotatably connection of the handle 32 and the first spindle 21 is provided in such a manner, that an end section 21a of the first spindle 21 having a polygonal cross-section, preferably a hexagonal cross-section, penetrates into an opening 35 of the handle 32 having also a polygonal cross-section section. FIG. 6 shows such non-rotatably connection between the locking element 29 and the second spindle 28. However, in FIG. 6 the locking element 29 is not rotatable because of the interaction of the protrusion 31 of the housing with the slot 30 of the locking element 29.

### List of Reference Signs

10 thermostatic mixing valve
11 housing
12 first inlet port
13 second inlet port
14 outlet port
15 valve insert
16 tubular element
16a outer wall section
16b opening
16c opening
16d rib
17 thermal element
18 spring element
18a end
18b end
19 first setting unit
20 second setting unit
21 first spindle
21a end section
21b stop
22 second spindle
22a end section
23 outer thread
24 inner thread
25 outer thread
26 inner thread
27 front element
27a front surface
27b back surface
28 actuator
29 locking element
30 slot
31 protrusion
32 handle
33 stop member
34 opening
35 opening

1. A thermostatic mixing valve comprising:
a housing, the housing comprising:
a first inlet port for water having a first temperature,
a second inlet port for water having a second temperature, and
an outlet port for mixed water having a mixing temperature depending on a mixing ratio of the water having the first temperature and of the water having the second temperature,
a valve insert positioned within the housing,
wherein the valve insert has a tubular element, a thermal element, and a spring element,
wherein the tubular element, the thermal element and the spring element of the valve insert control the mixing ratio of the mixed water such that an actual value of the mixing temperature corresponds to a nominal value of the mixing temperature,
a first setting unit having a first spindle and being configured to set the nominal value of the mixing temperature,
a second setting unit having a second spindle and being configured to select an operation mode of the thermostatic mixing valve,
wherein the second spindle is guided within the first spindle,
wherein the second spindle is configured to provide a linear movement of the second spindle relative to the first spindle when rotating the second spindle relative to the first spindle to select one of a first operation mode or a second operation mode for the thermostatic mixing valve.

2. The thermostatic mixing valve of claim 1, wherein in response to the first operation mode being selected by the second setting unit, the tubular element, the thermal element and the spring element control together the mixing ratio of the mixed water such that the actual value of the mixing temperature corresponds to the nominal value set by the first setting unit.

3. The thermostatic mixing valve of claim 1, wherein in response to the second operation mode being selected by the second setting unit, the thermal element and the spring element control together the mixing ratio of the mixed water such that the actual value of the mixing temperature corresponds to a disinfection value set by the second setting unit.

4. The thermostatic mixing valve of claim 1, wherein the first setting unit comprises the first spindle and a first handle
wherein the first handle and the first spindle are configured to provide a linear movement of the first spindle upon a rotation of the first handle to set the nominal value of the mixing temperature.

5. The thermostatic mixing valve of claim 1, wherein the first setting unit comprises the first spindle and a locking element,
wherein the first spindle is configured to provide a linear movement of the first spindle when rotating the first spindle to set the nominal value of the mixing temperature,
wherein the locking element is configured to lock the nominal value of the mixing temperature set by the first spindle.

6. The thermostatic mixing valve of claim 1, wherein the second setting unit comprises the second spindle and an actuator,
wherein the actuator is configured to provide the rotation of the second spindle relative to the first spindle,
wherein the second spindle is configured to provide the linear movement of the second spindle upon the rotation of the second spindle to select either the first operation mode or the second operation mode for the thermostatic mixing valve.

7. The thermostatic mixing valve of claim 6, wherein the actuator of the second setting unit is provided by a handle.

8. The thermostatic mixing valve of claim 6, wherein the actuator of the second setting unit is provided by a motor.

9. The thermostatic mixing valve of claim 1, wherein the first spindle comprises an outer thread engaging an inner thread of the housing.

10. The thermostatic mixing valve of claim 1, wherein the second spindle comprises an outer thread engaging an inner thread of the first spindle.

11. The thermostatic mixing valve of claim 1, wherein a rotation of the first spindle causes a linear movement of the first spindle and together with the linear movement of the first spindle a linear movement of the second spindle.

12. The thermostatic mixing valve of claim 1, wherein a rotation of the second spindle causes a linear movement of the second spindle while the position of the first spindle remains unchanged.

13. The thermostatic mixing valve of claim 1, wherein the second spindle comprises a front element with a front surface facing towards the thermal element,
wherein the thermal element abuts against the front surface of the front element second spindle.

14. The thermostatic mixing valve of claim 1, wherein a first end of the spring element of the valve insert abuts against the housing,
wherein a second end of the spring element of the valve insert abuts against the tubular element of the valve insert,
wherein the thermal element of the valve insert abuts against the tubular element of the valve insert.

15. The thermostatic mixing valve of claim 2, wherein in response to the second operation mode being selected by the second setting unit, the thermal element and the spring element control together the mixing ratio of the mixed water such that the actual value of the mixing temperature corresponds to a disinfection value set by the second setting unit.

16. The thermostatic mixing valve of claim 3, wherein the first setting unit comprises the first spindle and a first handle,
wherein the first handle and the first spindle are configured to provide a linear movement of the first spindle upon a rotation of the first handle to set the nominal value of the mixing temperature.

17. The thermostatic mixing valve of claim 8, wherein the first spindle comprises an outer thread engaging an inner thread of the housing.

18. The thermostatic mixing valve of claim 9, wherein the second spindle comprises an outer thread engaging an inner thread of the first spindle.

19. The thermostatic mixing valve of claim 10, wherein a first end of the spring element of the valve insert abuts against the housing,
wherein a second end of the spring element of the valve insert abuts against the tubular element of the valve insert,
wherein the thermal element of the valve insert abuts against the tubular element of the valve insert.

20. The thermostatic mixing valve of claim 10, wherein a rotation of the first spindle causes a linear movement of the first spindle and together with the linear movement of the first spindle a linear movement of the second spindle.
